(19) United States
(12) Patent Application Publication
(10) Pub. No.: US 2011/0138571 A1
(43) Pub. Date: Jun. 16, 2011

(54) Castor that can be Detached and Cleaned Easily and Quickly

(76) Inventor: Po-Chuan Tsai, Rende Hsiang (TW)

(21) Appl. No.: 12/638,039

(22) Filed: Dec. 15, 2009

(51) Int. Cl. B60B 33/00

(52) U.S. Cl. 16/30

(57) ABSTRACT

A castor includes a dustproof cover, a support shaft detachably mounted on the dustproof cover and two rollers mounted on the support shaft respectively and received in the dustproof cover respectively. The dustproof cover has an inner portion provided with a support post. The support post has a lower end provided with an arcuate locking recess detachably locked onto the support shaft. Thus, each of the rollers is encompassed by the dustproof cover completely so that the dustproof cover can isolate the rollers to prevent hairs, dirt or dusts from entering the rollers easily. In addition, the support shaft can be detached from the dustproof cover so that the support shaft and the rollers can be removed from the dustproof cover to facilitate the user clearing dirt, dusts or hairs accumulated in the dustproof cover and the rollers.

### BACKGROUND OF THE INVENTION

1. Field of the Invention

The present invention relates to a castor and, more particularly, to a castor for a chair and the like.

2. Description of the Related Art

A conventional castor 1 in accordance with the prior art shown in FIG. 5 comprises a dustproof cover 11 and a roller 10 rotatably mounted on the bottom of the dustproof cover 11. However, the dustproof cover 11 does not cover the two opposite sides of the roller 10, thereby decreasing the dustproof effect of the dustproof cover 11. In addition, the roller 10 cannot be removed from the dustproof cover 11 so that the user cannot clean the roller 10 and the dustproof cover 11 and cannot clear dirt, dusts or hairs accumulated in the roller 10 and the dustproof cover 11.

Another conventional castor 2 in accordance with the prior art shown in FIG. 6 comprises a castor body 20 and two rollers 21 rotatably mounted on two opposite sides of the castor body 20. However, the castor body 20 does not have a dustproof effect so that dirt, dusts or hairs easily enters the gap between the castor body 20 and the two rollers 21. In addition, the two rollers 21 cannot be removed from the castor body 20 so that the user cannot clean the two rollers 21 and the castor body 20 and cannot clear dirt, dusts or hairs accumulated in the two rollers 21 and the castor body 20.

### BRIEF SUMMARY OF THE INVENTION

In accordance with the present invention, there is provided a castor, comprising a hollow dustproof cover, a support shaft detachably mounted on the dustproof cover and two rollers mounted on two opposite ends of the support shaft respectively and received in the dustproof cover respectively. The dustproof cover has an inner portion provided with an upright support post. The support post of the dustproof cover has a lower end provided with an arcuate locking recess detachably locked onto the support shaft.

The primary objective of the present invention is to provide a castor that can be detached and cleaned easily and quickly.

According to the primary objective of the present invention, each of the two rollers is received in and encompassed by the dustproof cover completely so that the dustproof cover can isolate the two rollers to prevent hairs, dirt or dusts from entering the two rollers easily.

According to another objective of the present invention, the support shaft can be detached from the dustproof cover so that the support shaft and the two rollers can be removed from the dustproof cover to facilitate the user clearing dirt, dusts or hairs accumulated in the dustproof cover and the two rollers.

According to a further objective of the present invention, the locking recess of the support post has two opposite sides each provided with a guide ramp to introduce and guide the support shaft into the locking recess of the support post so as to facilitate insertion of the support shaft into the locking recess of the support post.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a castor in accordance with the preferred embodiment of the present invention.

FIG. 2 is an exploded perspective view of the castor as shown in FIG. 1.

FIG. 3 is a cross-sectional view of the castor taken along line 3-3 as shown in FIG. 1.

FIG. 4 is a cross-sectional view of the castor taken along line 4-4 as shown in FIG. 1.

FIG. 5 is a perspective view of a conventional castor in accordance with the prior art.

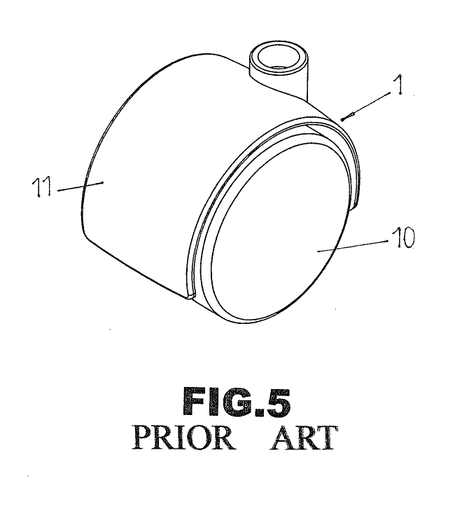

FIG. 6 is a perspective view of another conventional castor in accordance with the prior art.

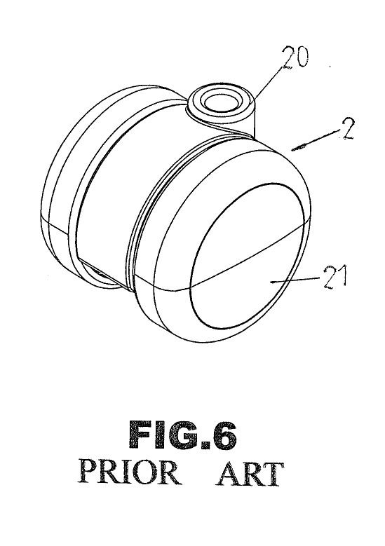

### DETAILED DESCRIPTION OF THE INVENTION

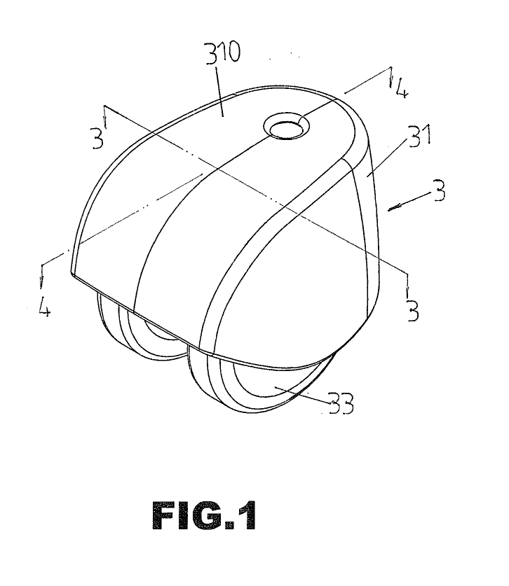

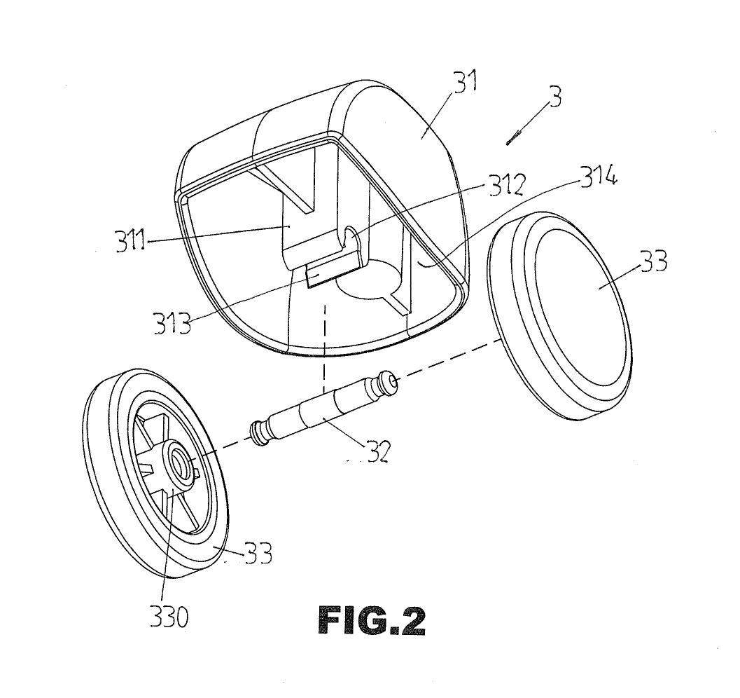

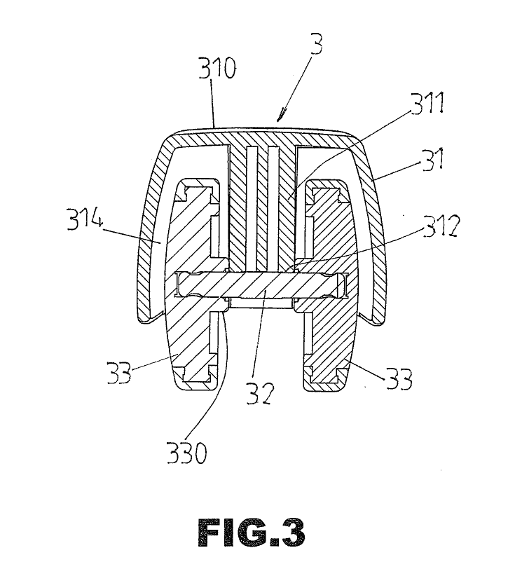

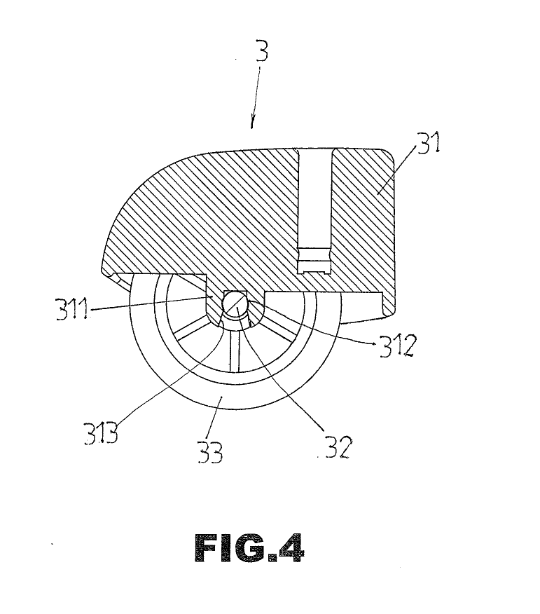

Referring to FIGS. 1-4, a castor 3 in accordance with the preferred embodiment of the present invention comprises a hollow dustproof cover 31, a support shaft 32 detachably mounted on the dustproof cover 31 and two rollers 33 mounted on two opposite ends of the support shaft 32 respectively and received in the dustproof cover 31 respectively.

The dustproof cover 31 has an inner portion provided with an upright support post 311. The support post 311 of the dustproof cover 31 has a lower end provided with an arcuate locking recess 312 detachably locked onto the support shaft 32. The locking recess 312 of the support post 311 has two opposite sides each provided with a guide ramp 313 to introduce and guide the support shaft 32 into the locking recess 312 of the support post 311. The guide ramp 313 of the locking recess 312 is gradually tapered outwardly from each of the two opposite sides of the locking recess 312 to facilitate insertion of the support shaft 32 into the locking recess 312 of the support post 311. Thus, the support shaft 32 is inserted between the guide ramps 313 of the two opposite sides of the locking recess 312 into the locking recess 312 of the support post 311.

The support post 311 of the dustproof cover 31 extends downward from a top plate 310 of the dustproof cover 31 and is located at a middle position of the dustproof cover 31. The support post 311 of the dustproof cover 31 is disposed between the two rollers 33, and each of the two rollers 33 has a protruding central portion 330 abutting the support post 311 of the dustproof cover 31. The inner portion of the dustproof cover 31 is divided by the support post 311 of the dustproof cover 31 into two receiving chambers 314 to receive the two rollers 33 respectively. Thus, each of the two rollers 33 is received in and encompassed by the dustproof cover 31 completely so that each of the two rollers 33 is isolated by the dustproof cover 31.

When a user wishes to detach the castor 3, the dustproof cover 31 is pulled upward to detach the locking recess 312 of the support post 311 from the support shaft 32 so as to detach the support shaft 32 and the two rollers 33 from the dustproof cover 31. Thus, the user can clean the inner portion of the dustproof cover 31 and the two rollers 33 so as to clear foreigners, such as dirt, dusts, hairs and the like, contained in the inner portion of the dustproof cover 31 and the two rollers 33. After the cleaning work is accomplished, the support post 311 of the dustproof cover 31 is mounted on the support shaft 32 so that the locking recess 312 of the support post 311 is locked onto the support shaft 32 so as to combine the dustproof cover 31 with the support shaft 32 and to receive the two rollers 33 into the dustproof cover 31.

Accordingly, each of the two rollers 33 is received in and encompassed by the dustproof cover 31 completely so that the dustproof cover 31 can isolate the two rollers 33 to prevent hairs, dirt or dusts from entering the two rollers 33 easily. In addition, the support shaft 32 can be detached from the dustproof cover 31 so that the support shaft 32 and the two rollers 33 can be removed from the dustproof cover 31 to facilitate the user clearing dirt, dusts or hairs accumulated in the dustproof cover 31 and the two rollers 33. Further, the locking recess 312 of the support post 311 has two opposite sides each provided with a guide ramp 313 to introduce and guide the support shaft 32 into the locking recess 312 of the support post 311 so as to facilitate insertion of the support shaft 32 into the locking recess 312 of the support post 311.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A castor, comprising:
a hollow dustproof cover;
a support shaft detachably mounted on the dustproof cover;
two rollers mounted on two opposite ends of the support shaft respectively and received in the dustproof cover respectively;
wherein the dustproof cover has an inner portion provided with an upright support post;
the support post of the dustproof cover has a lower end provided with an arcuate locking recess detachably locked onto the support shaft.

2. The castor of claim 1, wherein the locking recess of the support post has two opposite sides each provided with a guide ramp to introduce and guide the support shaft into the locking recess of the support post.

3. The castor of claim 2, wherein the guide ramp of the locking recess is gradually tapered outwardly from each of the two opposite sides of the locking recess to facilitate insertion of the support shaft into the locking recess of the support post.

4. The castor of claim 2, wherein the support shaft is inserted between the guide ramps of the two opposite sides of the locking recess into the locking recess of the support post.

5. The castor of claim 1, wherein the support post of the dustproof cover extends downward from a top plate of the dustproof cover.

6. The castor of claim 1, wherein the support post of the dustproof cover is located at a middle position of the dustproof cover.

7. The castor of claim 1, wherein the support post of the dustproof cover is disposed between the two rollers.

8. The castor of claim 7, wherein each of the two rollers has a protruding central portion abutting the support post of the dustproof cover.

9. The castor of claim 1, wherein the inner portion of the dustproof cover is divided by the support post of the dustproof cover into two receiving chambers to receive the two rollers respectively.

10. The castor of claim 1, wherein each of the two rollers is received in and encompassed by the dustproof cover completely so that each of the two rollers is isolated by the dustproof cover.
